(19) United States
(12) Patent Application Publication
(10) Pub. No.: US 2012/0090136 A1
(43) Pub. Date: Apr. 19, 2012

(54) Fully adjustable stirrup hinge

(75) Inventor: JERRY FIELDS, SAN ANTONIO, TX (US)

(73) Assignee: Jerry Fields, San Antonio, TX (US)

(21) Appl. No.: 12/906,544

(22) Filed: Oct. 18, 2010

(51) Int. Cl. E05D 5/10

(52) U.S. Cl. 16/386

(57) ABSTRACT

Fully Adjustable Stirrup Hinge apparatus includes a Square Head Bolt Assembly for tension, to attach to a vertical round steel post. The opposite end includes a Vertical Round Eyelet to provide for the male section of the Coarse Thread Horizontal Load Bolt to connect the device to moveability between the stationary round post and the moveable load attached to the Coarse Thread Horizontal Load Bolt.

### FIELD OF THE INVENTION

This invention relates to the Fully Adjustable Stirrup Hinge apparatus and method. In particular, in accordance with one embodiment. The invention relates to a Fully Adjustable Stirrup Hinge apparatus includes a tensioning bolt to attach to a vertical round steel post, the opposite end includes a vertical round eyelet to provide for the male section of the threaded horizontal load bolt to connect the device to a moveability between the stationary round post and the moveable load attached to the horizontal load bolt.

### BACKGROUND OF THE INVENTION

The Fully Adjustable Stirrup Hinge is user friendly and multiadjustable to provide moveable connectivity of wooden gates to steel fence posts. For example, 7/16″ to 9/16″ holes are to be precisely drilled to insert “J” bolts and hinge hardware related to chain link fencing, and brackets modified also for wood fencing. The drilled holes need to be precise in alignment and heighth, this weakens the strength of the steel post since it's diameter is smaller than prior art 4″×4″ treated wooden post, standard for fence compensation for repair and a complete removal and install is required. There is no prior art that shows the ability to hide its hinges for cosmetic and security purposes.

Therefore there is a need in the art to provide a Fully Adjustable Stirrup Hinge, that is user friendly, does not weaken the steel post, bolts into position, provides fast height adjustment, forward and rear alignment, top and bottom alignment, left to right alignment hinge, post security and concealment, and a 260 degree load moveability radius. The Fully Adjustable Stirrup Hinge art also provides adjustability for future sags, ground swell, post lean and minor damages causing leaning.

### SUMMARY OF THE INVENTION

Accordingly, The Fully Adjustable Stirrup Hinge and method of the present invention includes, according to one embodiment (2) two Coarse Thread Nuts, (2) two Wide Washers, Coarse Thread Load Bolt and Load Bolt Pin with Eyelet Rider oppositely opposing through a Vertical Eyelet of the second embodiment of the Stirrup Strap with Square Head Bolt Assembly.

Accordingly, the Load Bolt Pin, Eyelet Rider and Vertical Eyelet provide the connectivity of two hundred sixty degrees of swing radius between the vertical load and the horizontal load. In another aspect, the Square Head Bolt Assembly and Stirrup Strap provide the adjustable vertical connectivity for vertical load stabilization.

In another aspect, the coarse thread end of the Load Bolt in connection with the (2) two Coarse Thread Nuts and (2) two Wide Washers provide the adjustable horizontal connectivity and load management of the load.

### DETAILED DESCRIPTION OF THE INVENTION

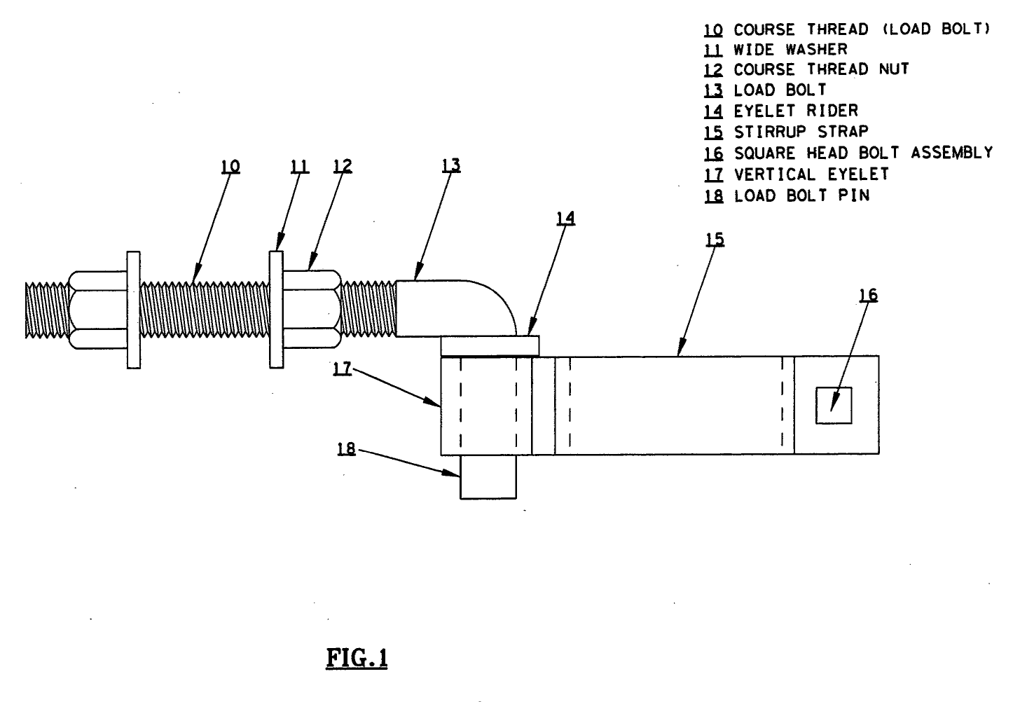

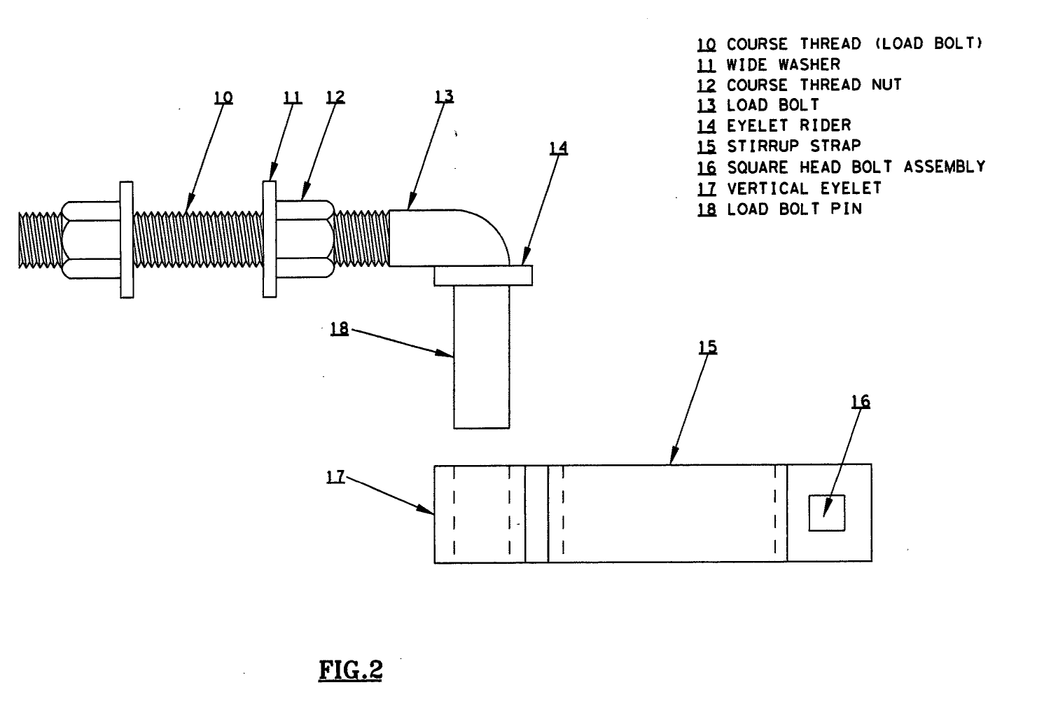

The preferred embodiment of the present invention is illustrated by way of example in FIGS. 1-4 with specific reference to (FIG. 1), the Fully Adjustable Stirrup Hinge apparatus, according to one embodiment of the present invention, includes a Load Bolt, (section 13), and a Stirrup Strap (section 15), the Eyelet Rider (section 14), and Load Bolt Pin (section 18), are connected through the Vertical Eyelet (section 17), provide connective moveability (FIG. 2) more clearly shows side view of connectivity and moveablility.

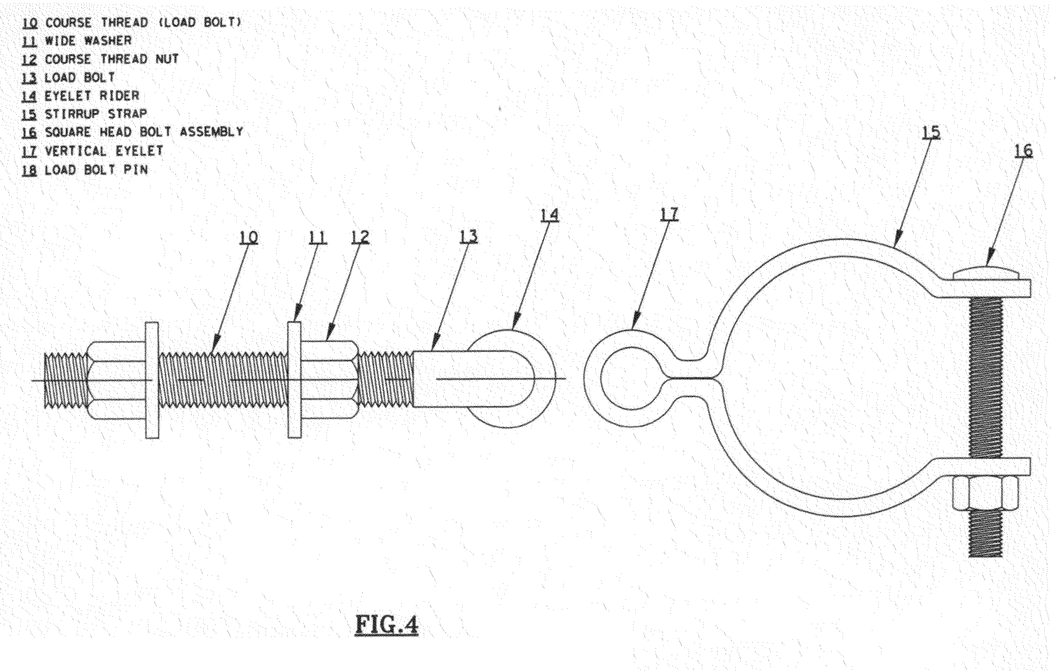

(FIG. 1) shows the Stirrup Hinge Strap (section 15), and Square Head Bolt Assembly (section 16), as more clearly shown in (FIG. 4), for adjustable vertical load management.

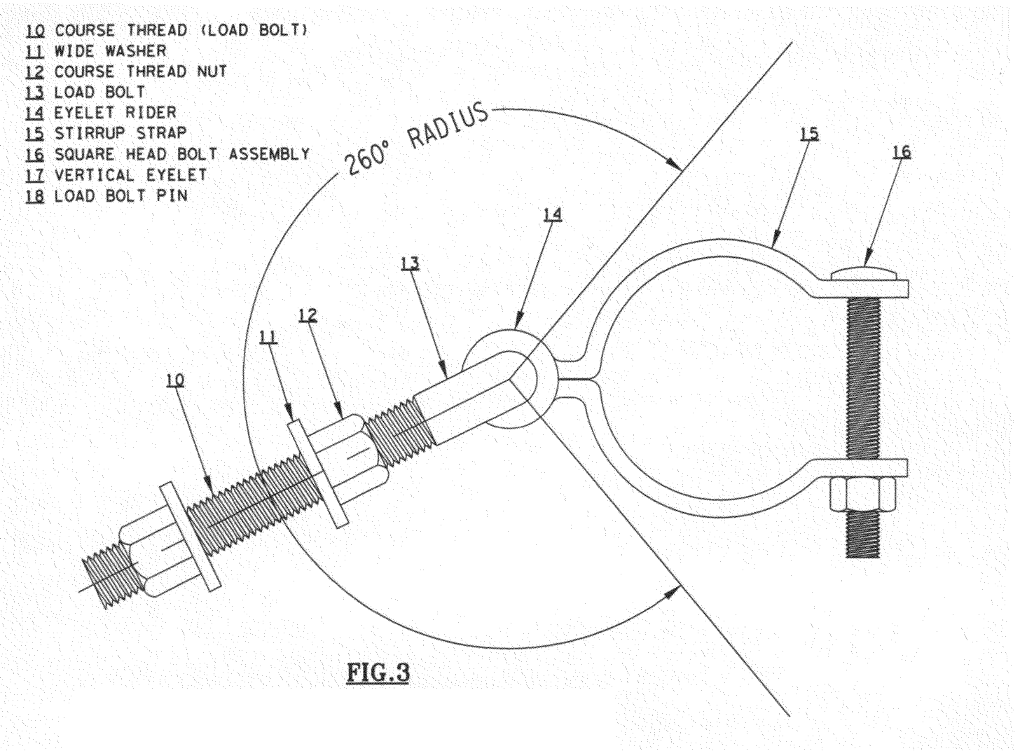

Referring now to (FIG. 3), a top view of the Fully Adjustable Stirrup Hinge apparatus shown “assembled” in connectivity and moveablility of (sections 13, 14), horizontal load management and shown in (sections 10, 11, 12), and with the fully useable two hundred sixty degree radius.

Metal fence post are more commonly being used in residential wood fence construction, the Fully Adjustable Stirrup Hinge is a perfect example of gate application of a wooden gate assembly using steel fence post of which the Fully Adjustable Stirrup Hinge apparatus is well suited.

The description of the present embodiments of the invention have been presented for purposes of illustration, but is not intended to be exhaustive or to limit the invention to the form disclosed. Many modifications and variations will be apparent to those of ordinary skill in the art as such, while the present invention has been disclosed in connection with an embodiment thereof, it should be understood that other embodiments may fall within the spirit and scope of the invention as defined in the following claims.

What is claimed is:

1. A Fully Adjustable Stirrup Hinge apparatus comprising:
A. A first connection of an Eyelet Rider, Coarse Thread Load Bolt and Load Bolt Pin, which extends through the Vertical Eyelet.
B. Coarse thread section, (2) two Coarse Thread Nuts and (2) two Wide Washers for horizontal load management.
C. The Stirrup Strap and Vertical Eyelet, used in connection moveability with Load Bolt Pin for a moveability radius of two hundred sixty degrees.
D. The Stirrup Strap and Square Head Bolt assembly, for adjustable vertical load stabilization and management.

2. The Fully Adjustable Stirrup Hinge apparatus of (claim 1), the first connection of Coarse Thread Load Bolt, Load Bolt Pin and Eyelet Rider, are at a ninety degree bend through the Vertical Eyelet.

3. The Fully Adjustable Stirrup Hinge apparatus of (claim 1), first connection Coarse Thread Load Bolt section, (2) two Coarse Thread Nuts and (2) two Wide Washers for wood gate horizontal load management and angle adjustment.

4. The Fully Adjustable Stirrup Hinge of (claim 1), first connection at connectivity of a two hundred sixty degree radius.

5. The Fully Adjustable Stirrup Hinge of (claim 1), Stirrup Strap, Square Head
Bolt Assembly to provide vertical load management.

6. The Fully Adjustable Stirrup Hinge of (claim 1), Stirrup Strap to Vertical Eyelet, to provide the second connection of moveability connect ability.
